(19) United States
(12) Patent Application Publication
(10) Pub. No.: US 2014/0272041 A1
(43) Pub. Date: Sep. 18, 2014

(54) METHODS OF REDUCING PATHOGENS DURING PROCESSING OR POST-PROCESSING OF BEEF, POULTRY AND OTHER MEAT PRODUCTS

(71) Applicant: BIRKO Corporation, Henderson, CO (US)

(72) Inventors: Terry L. MCANINCH, Westminster, CO (US); Ellis M. OWENS, Littleton, CO (US); Victor REUSCH, Arvada, CO (US)

(73) Assignee: BIRKO Corporation, Henderson, CO (US)

(21) Appl. No.: 14/288,247

(22) Filed: May 27, 2014

Related U.S. Application Data
(63) Continuation-in-part of application No. 12/924,314, filed on Sep. 24, 2010, now abandoned.
(60) Provisional application No. 61/277,468, filed on Sep. 25, 2009.

(51) Int. Cl. A23B 4/12

(52) U.S. Cl. CPC A23B 4/12
USPC 426/326

(57) ABSTRACT

A method for reducing the incidence of E. coli and Salmonella in slaughtered beef or other meat during processing or post-processing by treating the meat with an effective antimicrobial solution comprising lactic acid and a water soluble anionic or zwitterionic surfactant at a pH of about 3.2 or less. Mixtures of lactic acid with citric acid and a surfactant may also be employed. Antimicrobial solutions of lactic acid and surfactant may be used in other food processing applications.

### CROSS-REFERENCE TO RELATED APPLICATIONS

This application is a continuation-in-part of U.S. patent application Ser. No. 12/924,314, filed Sep. 24, 2010, which claims priority from provisional patent application Ser. No. 61/277,468 filed on Sep. 25, 2009.

### FIELD OF THE INVENTION

The present invention relates to improved methods for processing beef or other meat products in a manner that substantially reduces or eliminates E. coli, S. enterica, and other pathogens in the resulting meat products without affecting desirable characteristics of those products, such as their appearance, taste or aroma. The invention may also be employed to reduce E. coli, S. enterica, and other pathogens in processing other food products.

### BACKGROUND OF THE INVENTION

Food safety is an important issue in the food industry in general and particularly in the industry of supplying protein, i.e., edible “meat” products, from animals and poultry. By the very nature of the animals and birds, the conditions in which they are grown to suitable size, and the nature of the commercial slaughtering processes, “meat packers” face serious challenges in producing products that pass government and industry standards and are safe for consumption. When a problem arises in the slaughtering process, the consequences can be serious in terms of public health—exposing many individuals to serious health consequences, including possibly death. As evidenced by the recent massive recall of approximately 143 million pounds of beef, the economic consequences to meat packers, retailers and all those in the intermediate distribution chain can also be enormous.

Even after meat products leave the packing plant, they are subject to additional sources of contamination as they are “post-processed,” i.e., cut, tenderized, marinated, cooked and /or packaged into products desired by consumers. The nature and extent of this “post-processing,” has expanded considerably during the past decade as consumers with little time and refined palates have increasingly demanded that the meat supply chain deliver “ready-to-eat” products that are easily prepared into tender, tasteful meals. Each of these processing steps exposes the meat to further sources of contamination until the processed product is wrapped and isolated or served and consumed.

As used herein, “post-processing” refers to any step in processing meat after it leaves the packing plant. This includes a wide range of activities that may occur in the distribution process including wholesale (e.g., processing prior to delivery to a grocery store or restaurant), retail (e.g., processing at a grocery store, meat market, or restaurant) and even by a consumer. (e.g., processing prior to consumption). Risks of meat contamination are particularly high in post-processing events in which the meat contacts another surface, e.g., a cutting instrument—such as a knife or a mechanical tenderizer, such as a device with multiple elongated spikes or needles that are forced into the meat to break up the animal tissue, especially the muscle. “Needling” is used in the commercial processing of meat at wholesale and retail and is frequently used by consumers themselves to tenderize meat.

The problems of post-processing contamination have attracted government scrutiny. Indeed, indications are that a new regulatory protocol will soon be promulgated that would require that any commercial establishment (e.g., grocery store or restaurant) processing meat must employ an antimicrobial treatment (e.g., spray) prior to any processing (e.g., “cutting”) of uncooked meat. Among other things, such a regulation, if implemented, would require an antimicrobial intervention prior to any “needling” of meat. Currently, most antimicrobial “processing aids” such as this must result in a minimum of 1 log order reduction in the presence (i.e., population) of target organisms. This present invention is directed to compositions and methods that can be employed in the slaughter and processing operations of a meat packing plant or in post-processing. The compositions and methods described herein have industrial (e.g., meat packing plant), commercial (e.g., grocery store or restaurant) and consumer applications.

Many of the health issues in the meat industry involve the transmission and growth of microbial pathogens, e.g., Escherichia coli (“E. coli”), Salmonella and other pathogens that can cause sickness and death when ingested by humans. Indeed, Salmonella and another pathogen known as “Campylobacter” are the two leading bacterial causes of food poisoning in the United States. According to the Center for Disease Control, there are 40,000 reported cases of Salmonella poisoning and 600 deaths annually. The CDC estimates that the actual number of Salmonella cases is approximately 30 times the number of reported events. Encountering an immediate bout of illness caused by these pathogens may not be the only consequence. At least one recent report indicates that health effects associated with E. coli and other microbial pathogens may arise months or even years after the initial incident. (“Food Poisoning Legacy: Health Woes can arise Years after Bout, Doctors say,” by Lauran Neergaard reported in The Denver Post, Jan. 22, 2008.) Obviously, it is highly desirable for meat producers to deliver processed meat with minimal incidence of these bacteria.

While it is possible to promulgate regulations mandating a zero percent tolerance, i.e., incidence, for Salmonella and other pathogens in products leaving a production plant, no known process exists at the present time for achieving that lofty and desirable goal. While various chemical treatments have been tried, none of them have been able to achieve a zero tolerance efficacy level for Salmonella. Efforts to improve efficacy levels through the application of larger doses of chemical have been accompanied by discoloration of the meat and “off-smells” or tastes that are offensive or objectionable to potential purchasers and consumers. Many of the chemical treatments are quite expensive even at dosage levels that are not fully effective.

Despite continuing vigilance for E. coli contamination in beef carcasses and processed beef, E. coli continues to be a persistent problem. Reported cases of sickness and death continue to occur from red-meat contamination, and the industry continues to be at risk to expensive product recalls to correct deficiencies in meat processing and distribution. These health and economic consequences continue to occur despite significant efforts to avoid them.

Accordingly, there is a significant industry and public need for improved antimicrobial interventions that can effectively and inexpensively reduce the incidence of E. coli, Salmonella and other pathogens in beef, poultry and other meat products leaving the production plant and that can do so without adversely affecting the color, smell or taste of the meat.

### SUMMARY OF THE INVENTION

It has now been found that an effective antimicrobial combination of lactic acid and a surfactant can be used to address contamination of E. coli, S. enterica, and other pathogens, such as Salmonella, in the processing or post-processing of beef and other meats.

Although lactic acid has been known as an antimicrobial agent for spraying beef and other meat carcasses for a number of years, it has been discovered surprisingly that the addition of even a small amount of an anionic or zwitterionic surfactant to the lactic acid can result in a log kill of 2.5 or more for E. coli and S. enterica. Preferably, the antimicrobial agent and surfactant are applied at a pH of 3.2 or less. Lactic acid may be employed alone or may be combined with citric acid in a blend with the surfactant. The acid and surfactant may also be applied sequentially. The method of the present invention should not cause discoloration of the meat or impart an off-taste or smell to the meat products.

The combination of lactic acid and surfactant is a powerful antimicrobial agent that may be employed in a number of food processing applications.

### BRIEF DESCRIPTION OF THE DRAWINGS

FIG. 1 is a graph depicting the time course of the antimicrobial action of lactic acid on E. coli as described in Example 1.

FIG. 2 is a graph depicting the results of experiments regarding the antimicrobial effect of using a small amount of surfactant alone, i.e., without lactic acid, as described in Example 2.

FIG. 3 is a graph depicting the antimicrobial effect of adding surfactant to an aqueous lactic acid solution as described in Example 3.

FIG. 4 is a graph depicting the results of experiments regarding the antimicrobial effect of adding surfactant to aqueous lactic acid solutions with different concentrations as described in Example 4.

FIG. 5 is a graph depicting the results of an experiment using increasing concentrations of a reagent comprising lactic acid and surfactant in fixed wt./wt. ratio as an antimicrobial intervention as described in Example 5.

FIG. 6 is a graph depicting the results of an experiment showing the antimicrobial effect of using lactic acid followed by contact with a surfactant as described in Example 6.

FIG. 7 is a photograph depicting the results of an experiment showing the antimicrobial effect of lactic acid and an anionic surfactant (sodium 2-ethylhexyl sulfate) against E. coli as described in Example 7.

FIG. 8 is a graph depicting the results of experiments showing the antimicrobial effect of lactic acid with and without an anionic surfactant (sodium 2-ethylhexyl sulfate) against E. coli at various pH's as described in Example 8.

FIG. 9 is a graph depicting the results of experiments regarding the antimicrobial effect of various concentrations of lactic acid and an anionic surfactant (sodium lauryl sulfate) against E. coli as described in Example 9.

FIG. 10 is a graph depicting the results of experiments regarding the antimicrobial effect of lactic acid and various concentrations of an anionic surfactant (sodium lauryl sulfate) against E. coli as described in Example 10.

FIG. 11 is a graph depicting the results of an experiment varying the concentration in solution of antimicrobial compositions comprising lactic acid and anionic surfactants (sodium 2-ethylhexyl sulfate and sodium lauryl sulfate, separately) against E. coli, as described in Example 11.

FIG. 12 is a graph depicting the result of experiments regarding the antimicrobial effect of lactic acid and an anionic surfactant (sodium lauryl sulfate) against Salmonella as described in Example 12.

FIG. 13 is a graph depicting the results of an experiment varying the concentration in solution of antimicrobial compositions comprising lactic acid and anionic surfactants (sodium 2-ethylhexyl sulfate and sodium lauryl sulfate, separately) against Salmonella as described in Example 13.

FIG. 14 is graph depicting the results of experiments regarding the antimicrobial effect of a combination of lactic and citric acids with and without an anionic surfactant (sodium 2-ethylhexyl sulfate) against E. coli as described in Example 14.

FIG. 15 is a graph depicting the results of experiments regarding the antimicrobial effect of a combination of lactic and citric acids with and without an anionic surfactant (sodium 2-ethylhexyl sulfate) against E. coli as described in Example 17.

FIG. 16 is a graph depicting the results of experiments regarding the antimicrobial effect of a combination of lactic and citric acids with an anionic surfactant (sodium 2-ethylhexyl sulfate) against E. coli as described in Example 18.

### DETAILED DESCRIPTION OF THE INVENTION

The present invention is particularly suited for use in the processing of beef and other meats, e.g., pork, lamb, goat, rabbit, and other animals, at the packing plant. E. coli is the principal microbial pathogen at issue in beef slaughtering and processing facilities, but others may be implicated as well. Salmonella, for example, poses a significant risk, particularly if the meat packing plant contains an environment where fecal contamination is common. The same is true of meat packing facilities for other animals, such as pigs and lamb. The invention may also be applicable to the processing of poultry.

As used herein, “meat” is intended to include protein tissues from animals and poultry. “Meat packing” refers to the harvesting of live animals or birds (e.g., poultry) and processing to recover their meat.

In processing meat, the present invention can be implemented by applying an aqueous solution of 1.0 to 5.0 wt. % lactic acid plus the surfactant to carcasses pre-chill and/or post-chill to inhibit microbial activity. (As used herein, the concentration of antimicrobial agent in solution is specified in wt./wt. %.) More specifically, the solution of lactic acid and surfactant can be used up to 5.0 wt. % on livestock carcasses both pre-chill and post chill and in addition may be used at these levels on offal and variety meats. The combination of lactic acid and surfactant can be used in the range of 1.0 to 5.0 wt. % on beef and other meat and poultry trimmings up to a maximum temperature of about 55° C. (131° F.). And the combination can be applied at 2%-5.0 wt. % in the spray cabinets used on beef heads and tongues. The solution of lactic acid and surfactant may be used at any temperature. When used as a processing aid, the acid should not need to be declared as an ingredient per 21 CFR 101. 100(a)(3). The use of lactic acid cannot increase the carcass weight per 9 CFR 441. 10(c)(1) Lactic acid is GRAS per the FDA as indicated in 21 CFR 184.1061.

The foregoing constraints are based in part on current regulatory requirements regarding the use of lactic acid, e.g., the upper limit on concentration levels, and do not necessarily reflect effective or optimal conditions if those regulatory requirements were not in place. Solutions employing more than 5.0% lactic acid and surfactant might be employed effectively, but for governmental restrictions regarding the upper concentration limit of lactic acid compositions.

On the other hand, the enhancement in antimicrobial efficacy achieved by using a suitable surfactant with lactic acid or a blend of lactic and citric acids enables the use of less acid to achieve the same or a better result than using the acid by itself.

The combination of lactic acid and surfactant can be applied at many different places in the meat packing plant. One preferred point of application is immediately after the carcass wash. Another preferred point of application is in the “hot box.” Some meat packing plants currently employ multiple anti-contaminant “hurdles” (e.g., application of antimicrobial products, washing, etc.) at various points in the meat processing, and the application of lactic acid and surfactant could be one of those steps. In other words, application of an aqueous solution of lactic acid and surfactant mixture could be the principal antimicrobial treatment or it could be employed in conjunction with other antimicrobial interventions.

The antimicrobial agent used in the present invention comprises a combination of lactic acid and an anionic or zwitterionic surfactant. It has now been found that the addition of such a surfactant significantly enhances the antimicrobial effect over that achieved with lactic acid alone.

The surfactant employed should be anionic or zwitterionic and should be water soluble. Examples of suitable surfactants include sodium 2-ethylhexyl sulfate, phosphate ester of polyoxyalkylated fatty alcohol, sodium octane sulfonate, sodium lauryl sulfate (also known as “sodium dodecyl sulfate”) and coco amidoalkyl betaine. The antimicrobial efficacy of lactic acid combined with such surfactants is demonstrated, for example, in Example 15.

To be used in regulated, commercial operations, the surfactant should be considered GRAS or otherwise approved for safe use in the context of the application in which it is employed. Examples of suitable surfactants include: sodium ethyl hexyl sulfate, sodium lauryl sulfate, and sodium dioctyl sulfosuccinate.

One preferred surfactant is “Niaproof 08™” sold by Niacet Corporation (Niagara Falls, N.Y.), also known as “sodium ethylhexyl sulfate,” more properly known as “sodium 2-ethylhexyl sulfate” (i.e., 2-ethylhexanol sulfate sodium salt). Niaproof 08 is an aqueous solution of approximately 38.5 to 40.5% by weight of sodium 2-ethylhexyl sulfate. Sodium 2-ethylhexyl sulfate has GRAS status for food contact.

It is surprising that Niaproof 08 enhances antimicrobial activity when combined with lactic acid. As described herein, Niaproof by itself has no antimicrobial effect on E. coli.

Another preferred surfactant is “Stepanol WAC” sold by Stepan Company, Northfield, Ill., also known as sodium lauryl sulfate.) Stepanol WAC is an aqueous solution of approximately 28.5-30.5% by weight of sodium lauryl sulfate. Sodium lauryl sulfate has GRAS status for food contact.

Another preferred surfactant is sodium dioctyl sulfosuccinate, available, for example, as a 98% pure powder from Sigma-Aldrich, Milwaukee, Wis. Sodium dioctyl sulfosuccinate has GRAS status for food contact.

An example of a preferred zwitterionic surfactant is “Norfox CAPB” available from Norman, Fox & Co., Vernon, Calif., also known as “coco amidoalkyl betaine.” Norfox CAPB is an aqueous solution of approximately 30% by weight of coco amidoalkyl betaine.

The lactic acid may be employed in solution in amounts ranging from about 1 wt. % to approximately5.0 wt. %. Based on economics and efficacy, a preferred range is from about 1 wt. % to approximately 2.5 wt. %. Water is the preferred solvent. The lower range is the minimum amount required for anti-microbial efficacy. Indeed, it has been found that at concentrations much above 2.3 wt. %, there is a tendency for the lactic acid treatment to result in discoloration of the meat or an off-taste or smell.

Blends of lactic acid and citric acid may also be employed in the present invention. One such blend is “CL 21/80” available from Purac America, Inc., Lincolnshire, Ill. CL21/80 contains lactic acid and lactate in an amount of approximately 43-49 wt. % and citric acid and citrate in an amount of approximately 29-35 wt. %. The product is slightly buffered with potassium hydroxide so that it provides a pH of 2.0-2.2 in a 2.5% solution in water. Potassium is present in the product in an amount of about 1.2-1.5%. Improved antimicrobial results may be obtained by using blends of lactic and citric acid with an anionic or zwitterionic surfactant.

Preferred blends of lactic and citric acid suitable for use in the present invention are described in U.S. patent application Ser. No. 12/806.317, filed on Aug. 10, 2010, and incorporated by reference herein. Preferred blends include mixtures of lactic and citric acids in proportions containing a predominance of lactic acid down to a minimum of about 40:40 wt./wt. lactic acid to citric acid, and preferably ranging down to about 45:35 wt./wt. lactic acid to citric acid. In one embodiment preferred mixtures include lactic and citric acid in proportions of about 77:3 on a wt./wt. basis down to a minimum of about 45:35 wt./wt. lactic to citric acid and more preferably from about 75:5 wt./wt. lactic acid to citric acid down to about 50:30 lactic acid to citric acid. In situations where a solution is employed containing about 2% total acids, the preferred range is 77:3 down to a minimum of about 45:35 wt./wt. lactic acid to citric acid solution, and more preferably down to about 55:25 wt./wt. lactic acid to citric acid.

As described herein and in U.S. patent application Ser. No. 12/806.317, it has been found that the antimicrobial effects of lactic acid with an appropriate surfactant and blends of citric and lactic acid with an appropriate surfactant are best achieved at a pH of less than about 3.2 and preferably in the range of about 1.8 to 3.2. Even more preferably, the antimicrobial agent is applied at a pH of about 1.8 to about 3.0 and most preferably in the range of about 1.8 to about 2.5. The preferred pH ranges are intended to deliver effective antimicrobial activity and to minimize damage to the processing plant and equipment. The pH of the antimicrobial agents is achieved in commercial operations by adjusting the amount of acid(s) in solution.

Surfactant is included in the aqueous solution of the present invention in amounts ranging from about 0.005 to about 2.0 wt./wt. %, preferably from about 0.02 to about 0.2 wt./wt. %, and most preferably from about 0.05 to about 0.1 wt./wt. %.

As an alternative, it is also possible to achieve an enhanced antimicrobial effect by treating the meat with lactic acid or a combination of lactic and citric acids at a pH of about 3.2 or less followed by treatment with the surfactant, preferably at an approximately neutral pH. This has been observed in laboratory experimentation with E. coli. The antimicrobial efficacy of such a process is illustrated in Example 6.

When the present invention is employed in the post-processing of meat, the preferred method of application is to spray the meat before cutting or needling. In commercial applications this can occur at a spray station as the meat passes by on a conveyor. It may also be desirable to again apply the antimicrobial after the cutting or needling operation or to apply it to the cutting blade(s) or needles (s) prior to their contacting the meat. Application may occur for approximately 1 to 60 seconds, but application times of about 1-5 seconds are preferred.

As indicated, for example, by the following experiments the compositions and processes of the present invention have resulted in E. coli and, separately, S. enterica log kill reductions of 2.5 or more at commercially reasonable exposure times. In many instances, exposure to the antibacterial agents of the present invention has resulted in an elimination of detectable E. coli and S. enterica bacteria.

It should be noted that the antimicrobial agents of the present invention are effective at room temperature and do not require the additional cost of heating as some other antimicrobial interventions. It is also believed that the antimicrobial agents of the present invention may be effective at temperatures of approximately 24 degrees F. or above, i.e., temperatures that have historically been used in the “hot box” operations of typical meat packing plants.

Lactic acid is biodegradable and edible. A number of surfactants are GRAS as well as biodegradable, and the combination could be considered a “green product.”

### EXAMPLES

### Example 1

An experiment was performed to obtain baseline data on the antimicrobial effect of lactic acid on E. coli at various treatment times. The antimicrobial activity was assayed in aqueous suspensions of target bacteria (“reaction mixtures”) containing, in a volume of 1.0 ml, lactic acid, bacteria (usually 50 microliters of bacterial culture) and reagent material being tested, in this instance a solution of lactic acid. The tests were performed at ambient temperature (ca. 75 deg. F.). The “reaction” (i.e. interaction of antimicrobial agent and the target organism) was initiated by the addition of bacteria to the antimicrobial solution. The reaction was allowed to proceed for the respective time periods listed in Table I (i.e., at least 15 seconds each) and was terminated at the end of that time by adding quench buffer comprising 3.2 M potassium phosphate buffer, pH 7.2. The sample then was evaluated using serial 10-fold dilutions into sterile phosphate buffer as needed to determine, on Tryptic Soy agar (“TSA”), the titer of surviving bacteria. TSA is a medium that allows the growth of most bacteria.

The reduction in the bacterial count is expressed as the “log kill” which is defined as log₁₀ [initial cfu/ml]−log₁₀ [remaining cfu/ml]; where “cfu” refers to “colony forming unit.” All log kills reported herein are positive “base 10.”). Inasmuch as the standard assay mixture contained only ca. 25×10⁶ cfu initially (equivalent to 7.398 log) the theoretical maximum kill that can be measured with this assay system is ca. 7.4 log and the practical measuring limit is ca. 6 log. Therefore, high levels of log reduction were monitored by plating reaction mixtures directly (without dilution) onto agar medium. The results are reported in Table I and illustrated in graph format in FIG. 1. As illustrated in FIG. 1, when E. coli ATCC 14235 (a type strain) was treated with lactic acid for various times and then plated on TSA it was observed that as incubation time with lactic acid increased the log kill of bacteria also increased. The tests were replicated with E. coli ATCC 43888, a pathogenic strain of E. coli O157:H7.

TABLE I

| Time | ATCC 14235 | ATCC 43888 |
|---|---|---|
| (Secs.) | (Log Kill) | (Log Kill) |
| 0 | 0 | 0 |
| 15 | 1.431 | 1.24 |
| 30 | 2.217 | 1.76 |
| 45 | 3.246 | 1.89 |
| 60 | 3.722 | 2.63 |

### Example 2

An experiment was performed to determine whether the surfactant, Niaproof 08, has any antimicrobial effect alone, i.e., absent the lactic acid.

In each instance a target sample was employed using approximately 50 micro liters of an SAC-2 culture. E. coli “SAC-2,” was a Gram-negative strain isolated from municipal sewage. The tests were performed at room temperature, i.e., 75 deg. F. The “reaction” was permitted to proceed for 15 seconds and was terminated by the introduction of a quench buffer comprising phosphate buffer, pH 7.2. The results of each test sample were evaluated using a series of 10-fold dilutions as needed to determine, on a standard plating agar (TSA), the titer of bacteria that survived the antimicrobial treatment.

The same procedure was employed as in Example 2, but the only agent added to the target solution was Niaproof 08. No lactic acid was employed. The data are reported in Table II and in FIG. 2.

TABLE II

| Niaproof 08 | |
|---|---|
| (% wt./wt.) | cfu per ml |
| 0.00 | 4.18E+07 |
| 0.02 | 4.05E+07 |
| 0.06 | 3.63E+07 |
| 0.14 | 4.25E+07 |
| 0.20 | 4.15E+07 |

Table II indicates and FIG. 2 depict the amount of surfactant utilized and the resulting cell count.

The results of this “control” show that Niaproof 08 by itself has no antimicrobial effect on the target bacteria.

This result was confirmed with E. coli ATTC 12435 as follows:

TABLE II-A

| Niaproof 08 | |
|---|---|
| (% wt./wt.) | cfu per ml |
| 0.00 | 3.41E+07 |
| 0.02 | 3.41E+07 |
| 0.06 | 3.43E+07 |
| 0.14 | 3.56E+07 |
| 0.20 | 3.04E+07 |

### Example 3

Experiments were performed to ascertain the effect of adding small amounts of a surfactant, i.e., Niaproof 08, in an antimicrobial solution comprising 2.5 wt. % of lactic acid. The lactic acid solution and Niaproof 08 were added simultaneously to an aqueous target sample of E. coli “SAC-2.”

The results for 2.5 wt. % lactic acid at various surfactant concentrations are reported in Table III and illustrated in FIG. 3.

TABLE III

| Niaproof 08 | Log | “Enhancement |
|---|---|---|
| (wt./wt. %) | Kill | Factor*” |
| 0.00 | 0.456 | 1.00 |
| 0.02 | 1.08 | 2.37 |
| 0.04 | 1.74 | 3.82 |
| 0.08 | 4.8 | 10.5 |
| 0.12 | 6.1 | 13.4 |
| 0.16 | 6.1 | 13.4 |
| 0.20 | 6.1 | 13.4 |

*The “enhancement factor” = log₁₀ kill (in presence of lactic acid and surfactant) divided by log₁₀ kill (in presence of lactic acid only).

The x-axis on FIG. 2 indicates the concentration of Niaproof 08 employed in the test. The line represented by the diamond-shaped points indicates the minimum E. coli log kill reduction as shown on the scale on the left side of the chart. The line represented by the square-shaped points refers to the factor of enhancement of log kill over the control (lactic acid only) as referenced on the scale on the right side of the graph. The two points indicated on the y-axis were obtained in the absence of surfactant.

The data demonstrates a substantial increase in the rate of bacterial kill when lactic acid and surfactant are combined as an antimicrobial agent.

In order to confirm in some instances that the observed lack of growth at higher concentrations of Niaproof 08 was not caused by carryover of toxic materials from the reaction mixture into the agar, fresh bacterial culture was secondarily inoculated onto these plates by streaking. Growth occurred over the entire surface of the plates, verifying that the medium still supported growth of this bacterial strain and suggesting that a complete kill had, in fact, occurred in the reaction mixtures.

FIG. 3 illustrates that the addition of even a small amount of Niaproof 08 markedly improves the log kill reduction by lactic acid on E. coli. At a concentration of about 0.2 wt./wt. %, the surfactant and lactic acid combination produced a log kill of almost 6 in 15 seconds at room temperature. At concentrations above that, there was complete elimination of detectable E. coli under these conditions.

Similar results were obtained with E. coli ATTC 12435 as follows:

TABLE III-A

| Niaproof 08 | Log | “Enhancement |
|---|---|---|
| (wt./wt. %) | Kill | Factor” |
| 0.00 | 2.283 | 1.0 |
| 0.02 | 3.469 | 1.52 |
| 0.04 | 3.259 | 1.43 |
| 0.06 | 6.367 | 2.79 |
| 0.10 | 6.539 | 2.86 |

### Example 4

An experiment was performed to determine the antimicrobial effect of using a lower concentration of lactic acid together with a higher concentration of surfactant. The same protocol was employed as in Example 2, except that the antimicrobial mixture was a 1.5 wt. % solution of lactic acid. The target bacteria were treated with the lactic acid and Niaproof 08 in the amounts indicated for 15 seconds at ambient temperature, (i.e., 75 degrees F.) before quenching. The mixture was then diluted and plated as previously described. The results are reported in Table IV and are graphed in

FIG. 4.

TABLE IV

| Niaproof 08 | Log Kill | Log Kill |
|---|---|---|
| % wt./wt. | 1.5% Lactic Acid | 2.5% Lactic Acid |
| 0.00 | 0.336 | 0.456 |
| 0.02 | 0.575 | 1.080 |
| 0.04 | 1.060 | 1.740 |
| 0.06 | 1.011 | — |
| 0.08 | 2.110 | 4.800 |
| 0.10 | 2.770 | — |
| 0.12 | 2.820 | 6.100 |
| 0.16 | 5.980 | 6.100 |
| 0.20 | 5.980 | 6.100 |

FIG. 4 shows the amount of surfactant added to the SAC-2 target solution as indicated on the x-axis, and the log kill reduction is indicated on the y-axis. One line on the chart represents the antimicrobial effect of 1.5% solution of lactic acid plus various amounts of the surfactant as derived from this experiment. The other line represents the antimicrobial effect of 2.5% lactic acid plus various amounts of surfactant as derived from Example 2.

The results indicate that the addition of larger amounts of surfactant offset the loss in efficacy from using a less concentrated solution of lactic acid. Thus, the substitution of a lower cost quantity of surfactant for the higher cost quantity of lactic acid can achieve a similar antimicrobial effect.

### Example 5

An experiment was performed to determine whether it would be possible to produce a stable concentrated product comprising lactic acid and Niaproof 08 that could be diluted at the time of use instead of having to mix lactic acid and the Niaproof 08 surfactant at the time of use. The mixture (“reagent”) was prepared by admixing Niaproof 08 (40% wt./wt.) to lactic acid (88% wt./wt.). This resulted in a reagent composition of approximately 5.5% Niaproof (wt./wt. %) in 76% lactic acid (wt./wt. %). Increasing amounts of reagent were added to a series of test tubes. As before, each reaction (1.0 ml total volume) was initiated by addition of bacteria, incubated at ambient temperature (i.e., 75 degrees F.) for 15 seconds and terminated by addition of quench buffer (phosphate, pH 7.2). The bacterial titer of each mixture was determined by preparation and plating of serial dilutions on TSA.

The results are reported in Table V and are graphed in FIG. 5.

TABLE V

| Lactic Acid and | |
|---|---|
| Niaproof 08 | |
| “Reagent” in | |
| solution | E. coli (SAC-2) |
| (wt./wt. %) | (Log Kill) |
| 0.54 | 0.079 |
| 1.07 | 0.13 |
| 1.6 | 2.08 |
| 2.14 | 6.00 |
| 2.68 | 6.00 |

FIG. 5 indicates the weight percentage on the x-axis based on the weight of mixture added, not the weight of acid or surfactant. The results show that this antimicrobial mixture gave a 2 log kill of E. coli SAC-2 at 1.5 wt./wt. % reagent and eliminated bacteria at 2.0 wt./wt. % reagent and above. The results were confirmed with E. coli ATTC 12435 as follows:

TABLE V-A

| Lactic Acid and | |
|---|---|
| Niaproof 08 | |
| “Reagent” in | E. coli ATTC |
| solution | 12435 |
| (wt./wt. %) | (Log Kill) |
| 0.54 | 0.122 |
| 1.07 | 1.176 |
| 1.6 | 3.330 |
| 2.14 | 5.342 |
| 2.68 | 5.342 |

### Example 6

An experiment was performed illustrating that it is possible to enhance the antimicrobial efficacy of using lactic acid alone by sequentially contacting target bacteria with a solution of lactic acid followed by exposure to a surfactant.

The same procedure was employed for contacting a lactic acid solution with bacteria as described in Example 1, except that Violet Red Bile agar (“VRBA”) was employed for plating bacteria rather than the Tryptic Soy Agar (“TSA”) used in Example 1. VRBA was designed for the enumeration of coliform bacteria by selecting against most other common bacteria. The principal difference between TSA and VRBA—besides the presence of indicator dyes in VRBA—is the inclusion of bile salts in the VRBA. Historically, bile salts were added to media used to culture intestinal bacteria in order to mimic the intestinal environment more closely. Bile salts also happen to be anionic surfactants.

Plating of serial dilutions of E. coli SAC-2 made in dilute phosphate buffer (pH 7.2) on VRBA was completed in less than 15 minutes after termination of individual reaction mixtures by addition of quench buffer (phosphate, pH 7.2). Thus, contact with the surfactant in VRBA was made in less than 15 minutes and more than 8 minutes after reaction termination. Furthermore, the bacteria contacted the surfactant in VRBA under conditions of approximately neutral pH, unlike the conditions described in Examples 2, 4 and 5 where lactic acid and surfactant contacted bacteria simultaneously and under acidic conditions of pH.

The results of the tests are reported in the Table VI and in FIG. 6.

TABLE VI

| Time | Log Kill | Log Kill |
|---|---|---|
| (secs.) | (TSA) | (VRBA) |
| 0 | 0 | 0 |
| 15 | 0.188 | 0.509 |
| 30 | 0.439 | 2.812 |
| 45 | 0.801 | 3.330 |

The two media (TSA and VRBA) were inoculated from the same reaction mixtures and dilution series. The results show that a significant enhancement in the bacterial kill was observed on VRBA as compared with TSA. Thus, even though contact with surfactant was delayed for bacteria plated on VRBA, and even though the contact occurred at neutrality, enhancement of bacterial kill was observed. These results suggest that the sub-lethal injury suffered by the bacteria upon exposure to lactic acid can be exploited and magnified by delayed application of surfactant under conditions of neutral pH. Thus, the benefits of the present invention can also be obtained when treatment with lactic acid is followed by contact with a surfactant, preferably at an approximately neutral pH.

The observations were confirmed with E. coli ATTC 12435 as follows:

TABLE VI-A

| Time | Log Kill | Log Kill |
|---|---|---|
| (secs) | (TSA) | (VRBA) |
| 0 | 0 | 0 |
| 15 | 1.431 | 5.328 |
| 30 | 2.217 | 5.328 |
| 45 | 3.246 | 5.328 |
| 60 | 3.722 | 5.328 |

### Example 7

Experiments were performed to ascertain the effect of adding small amounts of a surfactant, i.e., Niaproof 08, in an antimicrobial solution comprising 2.5 wt. % of lactic acid. The lactic acid solution and Niaproof 08 were added simultaneously to an aqueous target sample of the pathogen E. coli ATCC 43888. The tests were performed at room temperature.

Visual observations of the antimicrobial effect of 2.5 wt. % lactic acid at various surfactant concentrations are reported in Table VII and illustrated in the reaction mixture streak plate of E. coli shown in the photograph of FIG. 7.

TABLE VII

| Niaproof 08 | Description/ |
|---|---|
| (% wt./wt.) | Observation |
| 0 | Extensive bacterial growth. |
| 0.02 | Extensive bacterial growth. |
| 0.04 | No bacterial growth. |
| 0.06 | No bacterial growth. |
| 0.08 | No bacterial growth. |
| 0.10 | No bacterial growth. |

The data demonstrate that when the concentration of surfactant was at or above 0.04% that all bacteria added to the reaction mixture were killed by the combination of lactic acid and surfactant as an antimicrobial agent.

### Example 8

An experiment was performed to test the antimicrobial effect of a mixture of lactic and a surfactant (i.e., Niaproof 08) at various pH conditions. The test employed lactic acid at a concentration of 2.5% (wt./wt. %). The tests were performed for a treatment duration of 20 secs. at a temperature of 73 deg. F. The protocol consisted of exposing the bacteria (i.e., E. coli ATCC 43888) to the antimicrobial agent at the denoted pH, achieved by pre-mixing the quenching buffer with the acid. The reaction was stopped after 20 seconds by addition of a sample of the reaction mixture to dilute phosphate buffer (100-fold dilution). The surviving bacteria were enumerated as for the other examples. The results are shown in Table VIII and in FIG. 8:

TABLE VIII

| | Lactic Acid | +Niaproof 08 |
|---|---|---|
| pH | (Log Kill) | (Log Kill) |
| 2.19 | 2.44 | 5.75 |
| 2.42 | 2.71 | 3.17 |
| 2.59 | 1.81 | 3.81 |
| 2.74 | 1.21 | 4.94 |
| 2.86 | 0.732 | 5.01 |
| 3.24 | 0.117 | 0 |
| 3.67 | 0.041 | 0 |

TABLE IX

| Sodium Lauryl | in 2.5% | in 1.5% |
|---|---|---|
| Sulfate in | Lactic | Lactic |
| Lactic Acid | Acid | Acid |
| (wt./wt. %) | (Log Kill) | (Log Kill) |
| 0 | 2.2 | 0.403 |
| 0.02 | 4.81 | 5.52 |
| 0.04 | 4.81 | 5.83 |
| 0.06 | 5.81 | 5.34 |
| 0.08 | 5.81 | 5.83 |
| 0.10 | 5.81 | 5.83 |

FIG. 9 shows the amount of surfactant added to the E. coli ATCC 43888 target solution as indicated on the x-axis, and the log kill reduction is indicated on the y-axis. One line on the chart represents the antimicrobial effect of 1.5% solution of lactic acid plus various amounts of the surfactant as derived from this experiment. The other line represents the antimicrobial effect of 2.5% lactic acid plus various amounts of surfactant as derived from this experiment.

The results indicate that the more dilute solution (1.5%) of lactic acid was as effective as the more concentrated solution (2.5%) of lactic acid when higher concentrations of surfactant were added to it.

### Example 10

An experiment was performed to determine the antimicrobial effect of adding very low concentrations of Stepanol WAC (i.e., sodium lauryl sulfate) to a 1.5% wt./wt. solution of lactic acid. The target bacteria (i.e., E. coli ATCC 43888) were treated with the lactic acid and sodium lauryl sulfate in the amounts indicated for 15 seconds at ambient temperature, (i.e., 75 degrees F.) before quenching. The mixture was then diluted and plated as previously described. The results from this experiment were compiled with the results from Example 9 (for solutions containing 1.5% lactic acid), and the combined results are reported in Table X and are plotted in FIG. 10.

TABLE X

| Sodium Lauryl | |
|---|---|
| Sulfate in 1.5 % | |
| Lactic Acid | |
| (wt./wt. %) | (Log Kill) |
| 0.000 | 0.403 |
| 0.004 | 2.08 |
| 0.08 | 4.8 |
| 0.012 | 5.92 |
| 0.016 | 5.92 |
| 0.020 | 5.52 |
| 0.020 | 5.92 |
| 0.040 | 5.83 |
| 0.060 | 5.34 |
| 0.080 | 5.83 |
| 0.100 | 5.83 |

These data show that—analogous to the results for Niaproof 08—sodium lauryl sulfate significantly enhances the kill of lactic acid against pathogenic E. coli. However, the enhancement of the kill with sodium lauryl sulfate occurs at surfactant concentrations lower than the concentration of Niaproof 08 needed to have an equal effect.

### Example 11

Experiments (similar to Example 5, above) were performed to determine whether it would be possible to produce a stable concentrated product comprising lactic acid and surfactant that could be diluted at the time of use instead of having to mix the lactic acid with the surfactant at the time of use and whether such a mixture would be effective against pathogenic E. coli ATCC 43888 (O157:H7). Mixtures (referred to herein as “reagents”) were prepared by combining Niaproof 08 or Stepanol WAC (i.e., sodium lauryl sulfate) in lactic acid resulting in reagent compositions containing approximately 5.4% Niaproof 08 in 75.9% lactic acid, or 0.70% sodium lauryl sulfate in 85.9% lactic acid. The balance was water. Increasing amounts of these “reagents” were added to a series of reaction tubes. As before each reaction was initiated by the addition of bacteria, incubated at ambient temperature for 15 seconds and terminated by addition of quench buffer. The tests were performed at room temperature. The bacterial titer of each mixture was determined by preparation and plating of on TSA of serial dilutions.

The results are reported in Table XI and graphed in FIG. 11.

TABLE XI

| Lactic Acid and | |
|---|---|
| Niaproof 08 | |
| “Reagent” | |
| in solution | |
| (wt./wt. %) | (Log Kill) |
| 0.00 | 0.00 |
| 0.55 | 0.08 |
| 1.08 | 1.00 |
| 1.63 | 3.85 |
| 2.17 | 5.76 |
| 2.72 | 5.76 |
| Lactic Acid | |
| and Sodium | |
| Lauryl Sulfate | |
| “Reagent” | |
| in solution | |
| (wt./wt. %) | (Log Kill) |
| 0.00 | 0.00 |
| 0.59 | 1.60 |
| 1.16 | 2.70 |
| 1.74 | 5.74 |
| 2.32 | 5.74 |
| 2.90 | 5.74 |

FIG. 11 indicates the weight percentage on the x-axis based on the weight of mixture added, not the weight of acid or surfactant. The results show that these prepared reagent mixtures were effective at killing the pathogen E. coli ATCC 43888. The Niaproof 08 reagent showed a 2 log kill at 1.3% wt./wt. % reagent and eliminated bacteria at 2.2% wt./wt. % reagent and above. The sodium lauryl sulfate reagent showed a 2 log kill at 0.75% wt./wt. % reagent and eliminated bacteria at 1.7% wt./wt. % reagent and above.

### Example 12

An experiment was performed (similar to Example 3, above) using 1.5% lactic acid with various amounts of Stepanol WAC against a target of the pathogen Salmonella enterica, ATCC 14028. As before, reaction mixtures were incubated for 15 seconds at room temperature (c. 74° F.). The results are depicted in Table XII and graphed in FIG. 12.

TABLE XII

| Sodium Lauryl | |
|---|---|
| Sulfate in 1.5% | |
| Lactic Acid | |
| (wt./wt. %) | (Log Kill) |
| 0.00 | 0.993 |
| 0.004 | 3.82 |
| 0.008 | 4.4 |
| 0.012 | 5.489 |
| 0.016 | 5.489 |
| 0.020 | 5.97 |

The data demonstrate that a substantial increase in antimicrobial kill of Salmonella occurs when lactic acid is combined with surfactant as an antimicrobial.

### Example 13

Experiments (similar to Example 11, above) were performed to determine whether it would be possible to produce a stable concentrated product comprising lactic acid and surfactant that could be diluted at the time of use instead of having to mix the lactic acid with the surfactant at the time of use. However, in this example the effectiveness of such mixtures was tested against Salmonella enterica, ATCC 14028. Mixtures (referred to herein as “reagents”) were prepared by combining Niaproof 08 or Stepanol WAC in lactic acid resulting in reagent compositions containing approximately 5.4% Niaproof 08 in 75.9% lactic acid, or 0.70% sodium lauryl sulfate in 85.9% lactic acid. The balance was water. Increasing amounts of these “reagents” were added to a series of reaction tubes.

As before each reaction was initiated by the addition of bacteria, incubated at ambient temperature for 15 seconds and terminated by addition of quench buffer. The tests were performed at room temperature. The bacterial titer of each mixture was determined by preparation and plating of serial dilutions on TSA. The results for both reagents are reported in Table XIII and graphed in FIG. 13.

TABLE XIII

| Lactic Acid and | |
|---|---|
| Niaproof 08 | |
| “Reagent” | |
| in solution | |
| (wt./wt. %) | (Log Kill) |
| 0.00 | 0.00 |
| 0.55 | 0.23 |
| 1.08 | 2.02 |
| 1.63 | 6.05 |
| 2.17 | 6.05 |
| 2.72 | 6.05 |
| Lactic Acid and | |
| Sodium | |
| Lauryl Sulfate | |
| “Reagent” | |
| in solution | |
| (wt./wt. %) | (Log Kill) |
| 0.00 | 0.00 |
| 0.59 | 2.72 |
| 1.16 | 6.18 |
| 1.74 | 6.18 |
| 2.32 | 6.18 |
| 2.90 | 6.18 |

FIG. 13 indicates the weight percentage on the x-axis based on the weight of mixture added, not the weight of acid or surfactant. The results show that these prepared reagent mixtures were effective at killing pathogen Salmonella enterica, ATCC 14028. The Niaproof 08 reagent showed a 2 log kill at 1.0% wt./wt. reagent and eliminated bacteria at 1.5% wt./wt. reagent and above. The sodium lauryl sulfate reagent showed a 2 log kill at 0.5% wt./wt. reagent and eliminated bacteria at 1.0% wt./wt. reagent and above.

### Example 14

An experiment was performed to determine whether the addition of a surfactant enhanced the antimicrobial effects of a blend of lactic and citric acids. Using the same procedures as previously described, a bacterial suspension of E. coli ATCC 12435 was treated at room temperature for 1 minute with a blend of lactic and citric acid (Purac CL21/80) or, alternatively, a blend of lactic and citric acids (Purac CL21/80) combined with Niaproof 08 (0.1% wt./wt.). In both cases the total concentration of acid in solution was 2.6% wt./wt.

The results are described in Table XIV and graphed in FIG. 14.

TABLE XIV

| Treatment | Log Kill |
|---|---|
| Cl21/80 | 0.484 |
| Cl21/80 + Niaproof 08 | 7.37 |

The results demonstrate that the addition of surfactant substantially increases the antimicrobial effect of lactic and citric acid blends.

### Example 15

An experiment was performed to find out if surfactants other than Niaproof 08 could enhance the effectiveness of lactic acid. To this end test tubes containing 2.5% (wt./wt. %) lactic acid, the surfactant to be tested (0.2% wt./wt. %) and the target bacteria (50 microliters of culture) were mixed to a total volume of 1.0 ml. After incubation for 15 seconds at ambient temperature the reaction was quenched by addition of phosphate buffer and the titer of surviving bacteria was determined by plating on TSA as described in the previous examples. The results are summarized in Table XV. The two nonionic surfactants proved to be relatively ineffective at enhancing the kill by lactic acid. The amphoteric and zwitterionic surfactants, which carry a net positive charge under the conditions of the reaction mixture, caused enhancement of the log kill by lactic acid. All anionic surfactants tested caused substantial enhancement of the log kill by lactic acid.

TABLE XV

| | | | Log Kill | |
|---|---|---|---|---|
| | | Log Kill | (Lactic | E. coli |
| | | (Lactic | Acid + | strain |
| Surfactant | Type | Acid) | Surfactant) | tested |
| T-Det N 9.5 | Nonionic | 0.083 | 0.18 | SAC-2 |
| Tween 80 | Nonionic | 0.083 | 0.18 | SAC-2 |
| Amphoterge | Amphoteric | 0.083 | 2.86 | ATCC 12435 |
| K2 | | | | |
| Sodium | Anionic | 1.95 | 6.67 | ATCC 12435 |
| dioctyl | | | | |
| sulfosuccinate | | | | |
| Niaproof 08 | ″ | 0.083 | 4.08 | SAC-2 |
| Niaproof 08 | ″ | 2.28 | 6.54 | ATCC 12435 |
| Klearfac | ″ | 0.083 | 2.56 | SAC-2 |
| AA270 | | | | |
| Klearfac | ″ | 1.55 | 6.31 | ATCC 12435 |
| AA270 | | | | |
| Bioterge | ″ | 0.31 | 6.31 | ATCC 12435 |
| PAS-8S | | | | |
| Stepanol | ″ | 0.77 | 6.43 | ATCC 12435 |
| WAC | | | | |
| Norfox CAPB | Zwitterionic | 1.49 | 6.25 | ATCC 12435 |

In all cases surfactant concentration was 0.2% (wt./wt. %) and lactic acid concentration was 2.5% (wt./wt. %) except for: Niaproof 08 (ATCC 12435 test) was 0.1% Niaproof 08; Stepanol WAC was 0.16% wt./wt. % WAC; and Norfox CAPB used 0.1% CAPB. Reaction time for all entries was 15 seconds. Reaction temperatures were in the range 74 degrees F. to 80 degrees F. Niaproof 08 (ATCC 12435 test) was conducted at 83 degrees F. Surfactants: T-Det N 9.5 (ethoxylated nonylphenol) available from Harcros Chemicals, Inc., Kansas City, Kans.; Tween 80 (Polyoxyethylene (20) sorbitan monooleate) available from Croda, Inc., New York, N.Y.; Amphoterge K2 (coconut based imidazoline, dicarboxylate, sodium salt) available from Lonza Inc. of Allendale, N.J.; Niaproof 08 (sodium 2-ethylhexyl sulfate) available from Niacet Corporation, Niagra Falls, N.Y.; Klearfac AA270 (phosphate ester of polyoxyalkylated fatty alcohol) available from BASF Corporation, Florham Park, N.J.; Bioterge PAS-8S (sodium octane sulfonate) available from Stepan Company, Northfield, Ill.; Stepanol WAC (sodium lauryl sulfate) available from Stepan Company, Northfield, Ill.; and Norfox CAPB (coco amidoalkyl betaine) available from Norman, Fox & Co., Vernon, Calif.

The results show that the non-ionic surfactants tested were not effective enhancers of the bacterial kill of lactic acid under these conditions. In contrast, a wide range of anionic and zwitterionic surfactants proved to be effective in enhancing the antimicrobial effect of lactic acid.

### Example 16

Meat samples were allowed to equilibrate to ambient temperature (74° F.) and inoculated with 25 μl of a late log phase culture of either Escherichia coli serotype O157:H7 (ATCC 43888) or Salmonella enterica serovar Typhimurium (ATCC 14028). Samples were allowed to rest for 10 minutes for the bacteria to attach. After attachment the inoculated samples were immersed in the treatment solutions as detailed in each experiment described below. After immersion, meat samples were immediately placed into a sterile Whirlpack Bag with 10-15 ml of neutralizing buffer to inactivate any residual antimicrobial on the meat surface. Samples were massaged for 3 minutes to extract surviving bacteria from the meat. Bacterial counts in the fluid were enumerated by plating on Violet Red Bile Agar (E. coli) or Salmonella Shigella Agar (Salmonella) and counting colonies after at least 16-24 hours of incubation.

### Example 17—E. coli

The meat samples described in Example 16 were treated with 4% (w/w) lactic acid supplemented with 0-1700 ppm of the anionic surfactant sodium lauryl sulfate, for 2 minutes at 108° F. The results of Meat Experiment #35 are shown in FIG. 16. This data demonstrates enhanced kill by lactic acid of E. coli 43888 on meat as sodium lauryl sulfate (SLS) concentration increases.

### Example 18—E. coli

The meat samples described in Example 16 were treated with 5% (w/w) total acid, containing various mixtures of lactic and citric acid supplemented with 1200 ppm of the anionic surfactant sodium lauryl sulfate, for 2 minutes at 109-111° F. Control: No sodium lauryl sulfate, 5% lactic acid only.

The results of Meat Experiment #40 are shown in FIG. 17. This data demonstrates that the antimicrobial activity against E. coli 43888 on meat of the 5% organic acid mixture is enhanced above 0.5% citric acid as the ratio between citric acid and lactic acid increases. At a ratio of 4:6 citric acid: lactic acid this is an enhancement of ca. 1.6 log which is equivalent to a 40 fold increase of microbial reduction of E. coli 43888 on meat surfaces when SLS is included.

### Example 19—E. coli

The meat samples described in Example 16 were treated with 5% (w/w) total acid (60% lactic+40% citric acid) with the addition of 0 or 1400 ppm of the anionic surfactant sodium lauryl sulfate (SLS), for 3 minutes at 109° F.

The results of Meat Experiment #42 are shown in Table XVI.

Table XVI

| Treatment Conditions | Log Reduction |
|---|---|
| 5% (w/w) total acid (60:40 | 1.18 |
| blend of lactic and citric) | |
| 5% total acid as above + | 2.74 |
| 1400 ppm SLS | |

This data demonstrates the enhanced reduction of E. coli 43888 on meat by addition of 1400 ppm of SLS to the 60:40 blend of lactic and citric acids. The enhancement of ca. 1.6 log which is equivalent to a 40 fold increase of microbial reduction of E. coli 43888 on meat surfaces when SLS is included.

### Example 20—S. enterica

The meat samples described in Example 16 were treated with 5% (w/w) total acid (60% lactic+40% citric acid) with addition of 1200 ppm of the anionic surfactant sodium lauryl sulfate (SLS) for 3 minutes at 108° F.

The results of Meat Experiment #43 are shown in Table XVII.

TABLE XVII

| Treatment Conditions | Log Reduction |
|---|---|
| 5% total acid as above + | 3.28 |
| 1200 ppm SLS | |

This data demonstrates a 3.28 log reduction of S. enterica 14028 on meat by SLS addition to the organic acid mixture can be observed.

What is claimed is:

1. A method for reducing the incidence of E. coli and Salmonella on slaughtered beef or other meat comprising treating the meat during meat packing operations with an effective antimicrobial solution comprising from about 1 wt. % to approximately 5.0 wt. % lactic acid and from about 0.005 to about 2.0 wt./wt. % of a water soluble anionic or zwitterionic surfactant at a pH of about 3.2 or less to achieve a kill rate of at least 2.5 log.

2. The method of claim 1 in which the surfactant is selected from the group consisting of: sodium 2-ethylhexyl sulfate, phosphate ester of polyoxyalkylated fatty alcohol, sodium dioctyl sulfosuccinate, sodium octane sulfonate, sodium lauryl sulfate and coco amidoalkyl betaine.

3. The method of claim 2 in which the antimicrobial solution also comprises an effective antimicrobial amount of citric acid.

4. The method of claim 2 in which the surfactant is sodium 2-ethylhexyl sulfate.

5. The method of claim 4 in which the antimicrobial solution also comprises an effective antimicrobial amount of citric acid.

6. The method of claim 2 in which the surfactant is sodium lauryl sulfate.

7. The method of claim 6 in which the antimicrobial solution also comprises an effective antimicrobial amount of citric acid.

8. The method of claim 2 in which the surfactant is sodium dioctyl sulfosuccinate.

9. The method of claim 8 in which the antimicrobial solution also comprises an effective antimicrobial amount of citric acid.

10. A method for reducing the incidence of E. coli and Salmonella on slaughtered beef or other meat comprising treating the meat during meat packing operations with an effective antimicrobial solution comprising from about 1 wt. % to approximately 5.0 wt. % lactic acid at a pH of about 3.2 or less followed by treating with a solution comprising from about 0.005 to about 2.0 wt./wt. % of a water soluble anionic or zwitterionic surfactant to achieve a kill rate of at least 2.5 log.

11. The method of claim 10 in which the surfactant is selected from the group consisting of: sodium 2-ethylhexyl sulfate, phosphate ester of polyoxyalkylated fatty alcohol, sodium dioctyl sulfosuccinate, sodium octane sulfonate, sodium lauryl sulfate and coco amidoalkyl betaine.

12. The method of claim 11 in which the lactic acid is applied with an effective antimicrobial amount of citric acid.

13. The method of claim 11 in which the surfactant is sodium 2-ethylhexyl sulfate.

14. The method of claim 13 in which the lactic acid is applied with an effective antimicrobial amount of citric acid.

15. The method of claim 11 in which the surfactant is sodium lauryl sulfate.

16. The method of claim 15 in which the lactic acid is applied with an effective antimicrobial amount of citric acid.

17. The method of claim 11 in which the surfactant is sodium dioctyl sulfosuccinate.

18. The method of claim 17 in which the antimicrobial solution also comprises an effective antimicrobial amount of citric acid.

19. In a method involving the cutting or needling of beef or other meat the improvement comprising: reducing the incidence of E. coli and Salmonella in or on the meat by treating the meat with an effective antimicrobial solution comprising from about 1 wt. % to approximately 5.0 wt. % lactic acid and from about 0.005 to about 2.0 wt./wt. % of a water soluble anionic or zwitterionic surfactant at a pH of about 3.2 or less to achieve a kill rate of at least 2.5 log.

20. The method of claim 19 in which the surfactant is selected from the group consisting of: sodium 2-ethylhexyl sulfate, phosphate ester of polyoxyalkylated fatty alcohol, sodium dioctyl sulfosuccinate, sodium octane sulfonate, sodium lauryl sulfate and coco amidoalkyl betaine.

21. The method of claim 20 in which the antimicrobial solution also comprises an effective antimicrobial amount of citric acid.

22. In a method involving the cutting or needling of beef or other meat the improvement comprising: reducing the incidence of E. coli and Salmonella in or on the meat by treating the meat with an effective antimicrobial solution comprising from about 1 wt. % to approximately 5.0 wt. % lactic acid at a pH of about 3.2 or less followed by treating with a solution comprising from about 0.005 to about 2.0 wt./wt. % of a water soluble anionic or zwitterionic surfactant to achieve a kill rate of at least 2.5 log.

23. The method of claim 22 in which the surfactant is selected from the group consisting of: sodium2-ethylhexyl sulfate, phosphate ester of polyoxyalkylated fatty alcohol, sodium dioctyl sulfosuccinate, sodium octane sulfonate, sodium lauryl sulfate and coco amidoalkyl betaine.

24. The method of claim 23 in which the lactic acid is applied with an effective antimicrobial amount of citric acid.
